(19) United States
(12) Patent Application Publication
(10) Pub. No.: US 2018/0217513 A1
(43) Pub. Date: Aug. 2, 2018

(54) METHOD OF MANUFACTURING ELECTROPHOTOGRAPHIC PHOTORECEPTOR, METHOD OF MANUFACTURING IMAGE FORMING APPARATUS INCLUDING THE SAME, AND ELECTROPHOTOGRAPHIC PHOTORECEPTOR MANUFACTURING APARATUS

(71) Applicant: KYOCERA CORPORATION, Kyoto (JP)

(72) Inventor: Haruki NAKATSUGAWA, Higashiomi-shi, Shiga (JP)

(21) Appl. No.: 15/747,137

(22) PCT Filed: Jun. 30, 2016
(86) PCT No.: PCT/JP2016/069563

§ 371 Date: Jan. 23, 2018

(30) Foreign Application Priority Data
Jul. 28, 2015 (JP) 2015-148850

(51) Int. Cl. G03G 5/082; G03G 5/10; G03G 5/147

(52) U.S. Cl. CPC G03G 5/08221; G03G 5/147; G03G 5/104

(57) ABSTRACT

There are provided a method of manufacturing an electrophotographic photoreceptor which achieves excellent enduring characteristics and reduction in occurrence of image defects, a method of manufacturing an image forming apparatus, and an electrophotographic photoreceptor manufacturing apparatus. A method of manufacturing an electrophotographic photoreceptor includes a step of roughening an outer surface of a cylindrical base body so that a surface roughness of the outer surface of the cylindrical base body satisfies Str≥0.70, in which Str denotes texture aspect ratio; a step of forming a charge injection blocking layer on the outer surface of the cylindrical base body; a step of forming a photoconductive layer on the charge injection blocking layer; and a step of forming a surface layer on the photoconductive layer.

### TECHNICAL FIELD

The present invention relates to a method of manufacturing an electrophotographic photoreceptor, a method of manufacturing an image forming apparatus including the same, and an electrophotographic photoreceptor manufacturing apparatus.

### BACKGROUND ART

Electrophotographic photoreceptors in the related art, for example, have a configuration in which photosensitive layers (such as carrier injection blocking layer, photoconductive layer, and surface protective layer) are formed on a surface of a base body having a cylindrical shape, as described in Patent Literature 1. Patent Literature 1 discloses that a surface roughness of the photosensitive layer is set within a predetermined numerical range by roughening the surface of the base body using a cutting tool or a rotary ball mill device.

### CITATION LIST

### Patent Literature

Patent Literature 1: Japanese Unexamined Patent Publication JP-A 10-268539 (1998)

### SUMMARY OF INVENTION

### Technical Problem

However, in cases where such an electrophotographic photoreceptor as described above is repeatedly used in an image forming apparatus a large number of times, a surface cover layer of the electrophotographic photoreceptor may inconveniently be smoothed or become worn due to friction with peripheral members. As employed herein, the peripheral members refer to a cleaning blade for removing a residual developer remaining on the surface of the electrophotographic photoreceptor, a charging roller for charging the surface of the electrophotographic photoreceptor, etc. In consequence, for example, the area of contact between the surface cover layer of the electrophotographic photoreceptor and the cleaning blade is increased, which results in an increase in frictional resistance, and the cleaning blade may hence chip off, causing image defects such as appearance of an unusual stripe on a printed image.

This has created demands for a method of manufacturing an electrophotographic photoreceptor which achieves excellent enduring characteristics and reduction in occurrence of image defects even under a large number of repetitive uses, and a method of manufacturing an image forming apparatus including the same.

### Solution to Problem

A method of manufacturing an electrophotographic photoreceptor according to an embodiment of the invention includes: a step of roughening an outer surface of a cylindrical base body so that a surface roughness of the outer surface of the cylindrical base body satisfies Str 0.70, in which Str denotes texture aspect ratio; a step of forming a charge injection blocking layer on the outer surface of the cylindrical base body; a step of forming a photoconductive layer on the charge injection blocking layer; and a step of forming a surface layer on the photoconductive Layer.

A method of manufacturing an image forming apparatus according to an embodiment of the invention includes: the method of manufacturing an electrophotographic photoreceptor according to the embodiment of the invention; and a step of installing a cleaning device in contact with a surface of the electrophotographic photoreceptor.

An electrophotographic photoreceptor manufacturing apparatus according to an embodiment of the invention includes: a surface roughening section which roughens an outer surface of the cylindrical base body so that a surface roughness of the outer surface of the cylindrical base body satisfies Str≥0.70, in which Str denotes texture aspect ratio; a charge injection blocking layer forming section which forms a charge injection blocking layer on the outer surface of the cylindrical base body; a photoconductive layer forming section which forms a photoconductive layer on the charge injection blocking layer; and a surface layer forming section which forms a surface layer on the photoconductive Layer.

According to the method of manufacturing an electrophotographic photoreceptor, the method of manufacturing an image forming apparatus, and the electrophotographic photoreceptor manufacturing apparatus according to the embodiment of the invention, by roughening the outer surface of the cylindrical base body so that a surface roughness of the outer surface of the cylindrical base body satisfies Str≥0.70, in which Str denotes texture aspect ratio, the characteristics of the layer formed on the outer surface of the cylindrical base body, for example, the surface layer, can be improved, thereby realizing excellent durability characteristics and low image defects.

### BRIEF DESCRIPTION OF DRAWINGS

FIG. 1(a) is a sectional view for explaining a method of manufacturing an electrophotographic photoreceptor according to an embodiment of the invention. FIG. 1(b) is a sectional view of a principal part of FIG. 1(a);

FIG. 2 is a vertical sectional view of a deposited film forming apparatus; and

FIG. 3 is a sectional view for explaining a method of manufacturing an image forming apparatus according to an embodiment of the invention.

### DESCRIPTION OF EMBODIMENTS

With reference to drawings, provided hereinafter are descriptions regarding a method of manufacturing an electrophotographic photoreceptor according to an embodiment of the invention and a method of manufacturing an image forming apparatus including the same. The contents below are merely for exemplification of the embodiments of the invention, and the invention is hence not limited to the examples of these embodiments.

(Electrophotographic Photoreceptor)

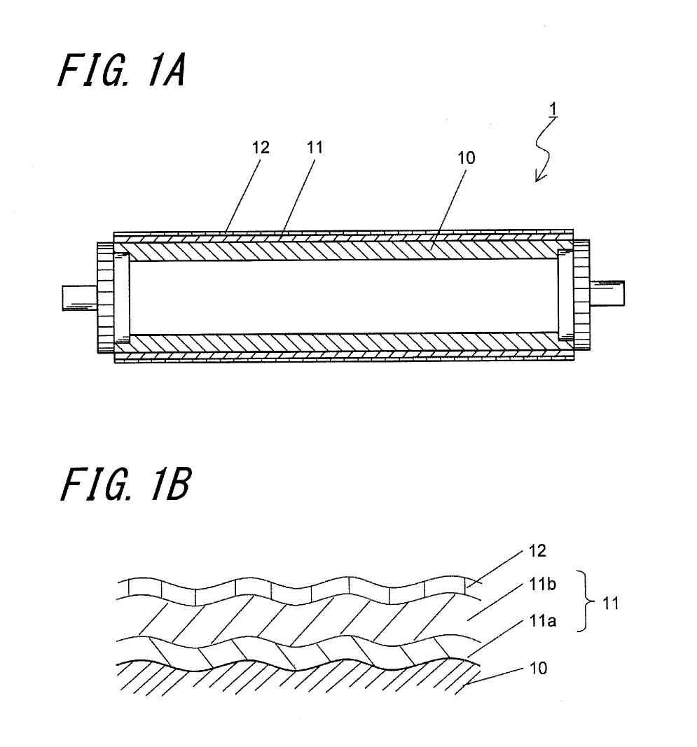

The following describes a method of manufacturing an electrophotographic photoreceptor according to an embodiment of the invention with reference to FIG. 1.

The electrophotographic photoreceptor 1 as shown in FIG. 1 comprises a cylindrical base body 10 having a photosensitive layer 11 obtained by sequentially forming a charge injection blocking layer 11a and a photoconductive layer 11b on an outer circumferential surface thereof, the photosensitive layer 11 having a surface layer 12 laminated thereover.

The cylindrical base body 10 serves as a support for the photosensitive layer 11, and, at least the surface of the cylindrical base body 10 has electrical conductivity.

The cylindrical base body 10 is formed of a metal material such for example as aluminum (Al), stainless steel (SUS), zinc (Zn), copper (Cu), iron (Fe), titanium (Ti), nickel (Ni), chromium (Cr), tantalum (Ta), tin (Sn), gold (Au), and silver (Ag), or an alloy material including such a metal material as exemplified, and has an electrical conductivity in its entirety. In the alternative, the cylindrical base body 10 may be constituted by laminating an electrically conductive film formed of the exemplified metal material and a transparent conductive material such as ITO (Indium Tin Oxide) or SnO₂ (tin dioxide) on the surface of an insulator such as resin, glass, or ceramics. Among those materials as exemplified, an aluminum (Al)-based material is suitable for use as the material for constituting the cylindrical base body 10, and, in this case, the cylindrical base body 10 may be entirely composed of the aluminum (Al)-based material. This makes it possible to produce a lightweight electrophotographic photoreceptor 1 at low cost, and in addition, by forming each of the charge injection blocking layer 11a and the photoconductive layer 11b of an amorphous silicon (a-Si)-based material, it is possible to increase the degree of adhesion between each layer and the cylindrical base body 10, and thereby achieve improvement in reliability.

Here, in the embodiment, a surface of the cylindrical base body 10 has been roughened. The surface roughness of the cylindrical base body 10 after roughening may be set to, for example, Str≥0.70. Further, the surface roughness of the cylindrical base body 10 after roughening may be set to be, for example, in a range of 0.3 μm≤Sal≤8.4 μm.

Examples of roughening methods include wet blasting, sputter etching, polishing, and turning processing. Specific examples of wet blasting will be described in detail in Examples which will be described later. In regards to the sputter etching, for example, physical processing may be performed by argon (Ar) plasma collision accelerated by applying a voltage while heating a base body in a reaction furnace while blowing Ar (Ar sputter etching). According to this, a large number of the cylindrical base bodies 10 can be processed simultaneously, and, in the case where the photosensitive layer 11 and the surface layer 12 are formed on the surface of the cylindrical base body 10, roughening and forming process of the photosensitive layer 11 and the surface layer 12 can be continuously carried out while maintaining vacuum inside a vacuum reaction chamber with a single apparatus using a chemical vapor deposition (CVD: Chemical Vapor Deposition) apparatus, which will be described later. In regards to the polishing, for example, a workpiece may be rotated against an abrasive-coated sheet while pressing the workpiece to apply an uneven pattern to the surface thereof, thus achieving a relatively short process time. In the case of performing sintered diamond cutting tool processing, as an example of the turning processing, a cutting tool in which, for example, diamond fine particles are sintered may be used, whereby the surface roughness of the cylindrical base body can be changed. Further, these processing methods may be performed singly or may be performed in combination. For example, the wet blasting may be performed after the polishing. Any drawing tube which satisfies the above surface roughness condition can be used as it is without adjusting the surface shape by roughening.

Further, in the embodiment, the surface of the cylindrical base body 10 may have been subjected to mirror finishing, which is not essential, before the surface roughening described above is performed. The surface roughness of the cylindrical base body 10 after mirror finishing may be set to be, for example, in a range of Sa<30 nm and Sz<2 μm. More specifically, the surface roughness thereof may be set to be in a range of 6 nm<Sa<20 nm and 0.05 μm<Sz<1.2 μm. After mirror finishing has been performed, oil content of the cylindrical base body 10 may be removed.

As employed in this specification, Str (Texture aspect ratio) refers to one of parameters indicative of three-dimensional surface texture defined by ISO 25178, which represents a texture aspect ratio of the surface. That is, Str is a measure of uniformity in surface texture, which is defined as the ratio between Sal and the farthest horizontal distance at which surface autocorrelation decays to the correlation value of 0.2. Str takes on values ranging from 0 to 1, and, the larger the Str value is, the greater the strength of isotropy is, and, on the other hand, the smaller the Str value is, the greater the strength of anisotropy is. Moreover, as employed in this specification, Sal (Shortest autocorrelation length) refers to one of parameters indicative of three-dimensional surface texture defined by ISO 25178, which represents the shortest autocorrelation length (μm). Sal represents the closest horizontal distance at which surface autocorrelation decays to the correlation value of 0.2. That is, it represents the dominant minimum asperity pitch in a horizontal direction. In the specification, the parameter Sa (arithmetic mean roughness) refers to the arithmetic mean roughness of the absolute value of the height from the average plane of the surface in the measurement target region (nm), which is one of the parameters defined by ISO 25178 representing three-dimensional surface texture properties. In the specification, the parameter Sz (maximum height) refers to the sum of the maximum peak height Sp of the surface and the maximum valley depth Sv in the measurement target region, which is one of the parameters defined by ISO 25178 representing three-dimensional surface texture.

As regards the surface texture of the electrophotographic photoreceptor 1, the entire area of the surface layer 12 does not necessarily have to fulfill the specified range. For example, at both ends or the like of the cylindrical base body 10 in an axial direction, which do not contact with a cleaning blade 116A, a surface texture thereof may fall outside the specified range. This holds true for all of surface texture parameters as set forth hereinbelow.

The charge injection blocking layer 11a serves to block injection of carriers (electrons) from the cylindrical base body 10.

The charge injection blocking layer 11a is formed of an amorphous silicon (a-Si)-based material, for example. As the charge injection blocking layer 11a, for example, it is possible to use a layer composed of amorphous silicon (a-Si) with boron (B), and, on an as needed basis, nitrogen (N) or oxygen (O), or both of them, added as a dopant, or amorphous silicon (a-Si) with phosphorus (P), and, on an as needed basis, nitrogen (N) or oxygen (O), or both of them, added as a dopant. The layer thickness is greater than or equal to 2 μm but less than or equal to 10 μm. The charge injection blocking layer 11a may be formed integrally with the cylindrical base body 10 by performing surface treatment on the surface of the cylindrical base body 10.

The photoconductive layer 11b serves to produce carriers by irradiation of light such as laser light.

The photoconductive layer 11b is formed of, for example, an amorphous silicon (a-Si)-based material and an amorphous selenium (a-Se)-based material such as Se—Te or As₂Se₃. The photoconductive layer 11b in this example is formed of amorphous silicon (a-Si) and an amorphous silicon (a-Si)-based material composed of amorphous silicon (a-Si) with carbon (C), nitrogen (N), oxygen (O), etc. added, and also with boron (B) or phosphorus (P) contained as a dopant.

Moreover, the thickness of the photoconductive layer 11b may suitably be determined in consideration of the photoconductive materials in use and desired electrophotographic characteristics, and, in the case of using an amorphous silicon (a-Si)-based material to form the photoconductive layer 11b, for example, the photoconductive layer 11b is set in thickness to greater than or equal to 5 μm but less than or equal to 100 μm, or more specifically greater than or equal to 10 μm but less than or equal to 80 μm.

The surface layer 12 serves to protect the surface of the photosensitive layer 11.

For example, the surface layer 12 may be formed of an amorphous silicon (a-Si)-based material such as amorphous silicon carbide (a-SiC) or amorphous silicon nitride (a-SiN), or of amorphous carbon (a-C), or may be given a multilayer structure composed of such materials. In this example, the surface layer 12 is configured to have a three-layer structure in which the third layer, viz., the outermost layer, of the surface layer 12 is formed of, from the standpoint of wear resistance against rubbing movement in the interior of the image forming apparatus, highly wear-resistant amorphous carbon (a-C).

In this embodiment, the surface roughness of the surface layer 12 may be defined as: Str≥0.67, or more specifically defined as: Str≥0.79. This makes it possible to achieve excellent enduring characteristics and reduction in image defects. That is, early-stage frictional resistance resulting from friction with, for example, the cleaning blade can be reduced, and, even if the surface becomes worn gradually during prolonged usage, the surface roughness can be maintained within a certain range. This makes it possible to permit continued reduction of an increase in frictional resistance between the surface layer and the cleaning blade effectively, and thereby restrain the cleaning blade from chipping off, wherefore image defects such as appearance of an unusual stripe on a printed image can be reduced.

Moreover, the surface roughness of the surface layer 12 may be defined as: Sal≤10.3 μm. The surface roughness of the surface layer 12 may also be defined as: Sal≥0.9 μm, or more specifically defined as: Sal≥1.6 μm. This makes it possible to achieve excellent enduring characteristics and reduction in image defects as above described more effectively. That is, in the presence of surface asperities arranged at narrow pitches as defined by the above-described numerical values in the planar direction of the surface of the surface layer, initial failure reduction, as well as reduction of an increase in frictional resistance during prolonged usage, can be achieved.

Sal and Str of the surface layer 12 refer to values indicative of the surface texture of the surface layer 12 of the electrophotographic photoreceptor 1 in an initial condition, or equivalently the electrophotographic photoreceptor 1 yet to be subjected to a large number of repetitive uses in the image forming apparatus. This means that the values are factory default values of the surface texture of the commercially delivered electrophotographic photoreceptor 1.

As the surface layer 12, it is possible to use a layer which excels in light transmission capability for prevention of absorption and reflection of light such as laser light applied to the electrophotographic photoreceptor 1, and also has a surface resistance value sufficient to retain an electrostatic latent image in an image-forming process (in general, a surface resistance value of greater than or equal to 10¹¹ Ω·cm).

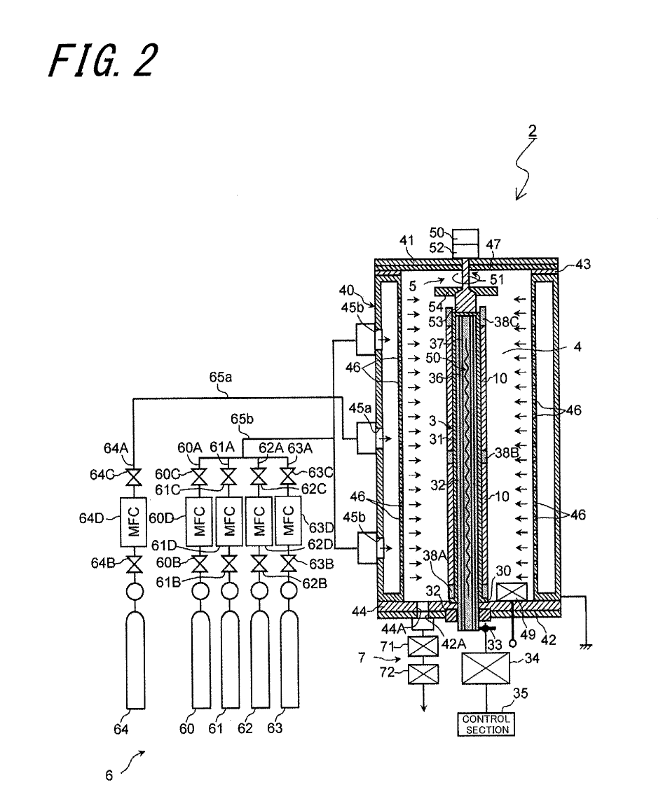

The charge injection blocking layer 11a, the photoconductive layer 11b, and the surface layer 12 constituting the electrophotographic photoreceptor 1 described above are formed by a plasma CVD (Chemical Vapor Deposition) system 2 as shown in FIG. 2, for example.

(Plasma CVD System)

The plasma CVD system 2 comprises a vacuum reaction chamber 4 which receives therein a support substrate 3, and also includes rotating means 5, raw material gas supply means 6, and exhaust means 7.

The support substrate 3 serves to support the cylindrical base body 10. The support substrate 3 is formed in the form of a hollow body having a flange portion 30 and is formed as a conductor in its entirety of an electrically conductive material similar to that used for the cylindrical base body 10. In the case of this example, the support substrate 3 is given a sufficient length to support two cylindrical base bodies 10, and is made attachable to and detachable from a conductive support column 31. Thus, the support substrate 3 allows for insertion and withdrawal of the two cylindrical base bodies 10 in and from the vacuum reaction chamber 4 without making direct contact with the surface of each of the supported cylindrical base bodies 10.

The conductive support column 31, is formed as a conductor in its entirety of an electrically conductive material similar to that used for the cylindrical base body 10, and is secured via an insulating material 32 to a plate 42 described later in a center of the vacuum reaction chamber 4 (a cylindrical electrode 40 described later). A DC power supply 34 is connected via a conducting plate 33 to the conductive support column 31. The DC power supply 34 is operated under the control of a control section 35. The control section 35 is configured to effect control of the DC power supply 34 in a manner so as to feed DC voltage in pulse form to the support substrate 3 through the conductive support column 31.

A heater 37 is housed inside the conductive support column 31 via a ceramic pipe 36. The ceramic pipe 36 serves to provide insulation and thermal conductivity. The heater 37 serves to heat the cylindrical base body 10. As the heater 37, a nichrome wire or a cartridge heater can be used, for example.

The temperature of the support substrate 3 is monitored by, for example, a non-illustrated thermocouple attached to the support substrate 3 or the conductive support column 31, and, on the basis of the result of monitoring by the thermocouple, the heater 37 is turned on or off to maintain the temperature of the cylindrical base body 10 within a target range, for example, a certain range comprising those selected from temperatures that are higher than or equal to 200° C. but less than or equal to 400° C.

The vacuum reaction chamber 4 serves as a space for forming a deposited film on the cylindrical base body 10, which is defined by the cylindrical electrode 40 and a pair of plates 41 and 42.

The cylindrical electrode 40 is cylindrically shaped so as to surround the support substrate 3. The cylindrical electrode 40 is formed as a hollow body of an electrically conductive material similar to that used for the cylindrical base body 10, and is joined via insulating members 43 and 44 to the pair of plates 41 and 42.

The cylindrical electrode 40 is formed to have such a size that a distance D1 between the cylindrical base body 10 supported on the support substrate 3 and the cylindrical electrode 40 is greater than or equal to 10 mm but less than or equal to 100 mm. The reason is that, when the distance D1 between the cylindrical base body 10 and the cylindrical electrode 40 is less than 10 mm, it is difficult to afford adequate working efficiency in, for example, insertion and withdrawal of the cylindrical base body 10 in and from the vacuum reaction chamber 4, as well as to achieve stable discharge between the cylindrical base body 10 and the cylindrical electrode 40, and that, when the distance D1 between the cylindrical base body 10 and the cylindrical electrode 40 is greater than 100 mm, the size of the plasma CVD system 2 is increased with consequent deterioration in productivity per unit installation area.

In the cylindrical electrode 40, there are provided gas introduction ports 45a and 45b and a plurality of gas outlet holes 46, and, the cylindrical electrode 40 is grounded at one end. However, the cylindrical electrode 40 does not necessarily have to be grounded, and may be connected to a reference power supply provided independently of the DC power supply 34. In the case of connecting the cylindrical electrode 40 to a reference power supply provided independently of the DC power supply 34, the reference power supply is set in reference voltage to higher than or equal to −1500 V but lower than or equal to 1500 V.

The gas introduction port 45a serves to introduce a raw material gas for exclusive use for the dopant of the photoconductive layer 11b, which is fed into the vacuum reaction chamber 4, and the gas introduction port 45b serves to introduce a raw material gas which is fed into the vacuum reaction chamber 4, each of the gas introduction ports 45a and 45b being connected to the raw material gas supply means 6. The gas introduction port 45a is positioned at a height about on a level with the center of the vacuum reaction chamber 4, and, the gas introduction port 45b is positioned at a height corresponding to the position of corresponding one of the ends of the support substrate 3 placed inside the vacuum reaction chamber 4.

The plurality of gas outlet holes 46 serve to allow the introduced raw material gas within the cylindrical electrode 40 to blow out toward the cylindrical base body 10, are arranged equidistantly in a vertical direction as seen in the drawing (axial direction of cylindrical electrode 40), and are also arranged equidistantly in a circumferential direction. The plurality of gas outlet holes 46 have the same circular shape, and, for example, the hole diameter of the gas outlet hole 46 is greater than or equal to 0.5 mm but less than or equal to 2 mm.

The plate 41 serves to effect selection between the opened state and the closed state of the vacuum reaction chamber 4, and, the opening and closing of the plate 41 permit insertion and withdrawal of the support substrate 3 in and from the vacuum reaction chamber 4. The plate 41 is formed of an electrically conductive material similar to that used for the cylindrical base body 10, and has a deposition blocking plate 47 attached to its lower side. This helps prevent formation of a deposited film on the plate 41. The deposition blocking plate 47 is also formed of an electrically conductive material similar to that used for the cylindrical base body 10. The deposition blocking plate 47 is made attachable to and detachable from the plate 41. Hence, the deposition blocking plate 47 can be cleaned out after being removed from the plate 41 for repetitive use.

The plate 42 constitutes the base of the vacuum reaction chamber 4, and is formed of an electrically conductive material similar to that used for the cylindrical base body 10. The insulating member 44 interposed between the plate 42 and the cylindrical electrode 40 serves to restrain arc discharge from arising between the cylindrical electrode 40 and the plate 42. For example, such an insulating member 44 can be formed of a glass material (borosilicate glass, soda glass, heat resisting glass, etc.), an inorganic insulating material (ceramics, quartz, sapphire, etc.), or a synthetic resin insulating material (fluorine resin such as tetrafluoroethylene, polycarbonate, polyethylene terephthalate, polyester, polyethylene, polypropylene, polystyrene, polyamide, vinylon, epoxy, a PEEK (polyether ether ketone) material, etc.). The insulating member 44 may be formed of, without special limitations, any material which has insulation properties, exhibits adequate heat resistance at operating temperatures, and emits little gas in a vacuum. It is to be noted that the insulating member 44 is made thick to above a certain extent to avoid that it becomes incapable of service due to warpage caused by an internal stress in the film-forming body, or a stress resulting from the bi-metallic effect entailed by an increase in temperature during film formation. For example, where the insulating member 44 is formed of a material having a coefficient of thermal expansion of greater than or equal to 3×10⁻⁵/K but less than or equal to 10×10⁻⁵/K such as tetrafluoroethylene, then the insulating member 44 is set in thickness to greater than or equal to 10 μm. By adjusting the thickness of the insulating member 44 within this range, it is possible to reduce the amount of warpage caused by a stress developed at the interface between the insulating member 44 and the amorphous silicon (a-Si) film, which is greater than or equal to 10 μm but less than or equal to 30 μm in thickness, formed on the cylindrical base body 10. For example, the amount of warpage can be set to 1 mm or below, with respect to 200 mm specified as the length in the horizontal direction (a radial direction substantially perpendicular to the axial direction of the cylindrical base body 10), in terms of the difference in axial height between the end part and the central part in the horizontal direction. This allows for repetitive use of the insulating member 44.

The plate 42 and the insulating member 44 are provided with gas discharge ports 42A and 44A and a pressure gauge 49. The gas discharge ports 42A and 44A serve to discharge gas present inside the vacuum reaction chamber 4, and are connected to the exhaust means 7. The pressure gauge 49 serves to monitor pressure in the vacuum reaction chamber 4, and, any of heretofore known various pressure gauges can be used for the pressure gauge 49.

As shown in FIG. 2, the rotating means 5 serves to rotate the support substrate 3, and comprises a rotary motor 50 and a rotational force transmitting mechanism 51. In the case of effecting film formation while rotating the support substrate 3 by the rotating means 5, the cylindrical base body 10 is rotated together with the support substrate 3, wherefore components resulting from decomposition of the raw material gas can be deposited evenly on the outer periphery of the cylindrical base body 10.

The rotary motor 50 imparts a rotational force to the cylindrical base body 10. For example, the rotary motor 50 is operated under control so as to rotate the cylindrical base body 10 at greater than or equal to 1 rpm but less than or equal to 10 rpm. Any of heretofore known various rotary motors can be used for the rotary motor 50.

The rotational force transmitting mechanism 51 serves to transmit and input the rotational force exerted by the rotary motor 50 to the cylindrical base body 10, and comprises a rotation-introducing terminal 52, an insulating shaft member 53, and an insulating flat plate 54.

The rotation-introducing terminal 52 serves to effect rotational force transmission while maintaining a vacuum in the vacuum reaction chamber 4. As such a rotation-introducing terminal 52, vacuum sealing means such as an oil seal or a mechanical seal can be used, with preparation of a rotating shaft having a dual or triplex structure.

The insulating shaft member 53 and the insulating flat plate 54 serve to input the rotational force exerted by the rotary motor 50 to the support substrate 3 while maintaining an insulating relation between the support substrate 3 and the plate 41, and are formed of an insulating material similar to that used for the insulating member 44, for example. An outside diameter D2 of the insulating shaft member 53 is set to a value smaller than an outside diameter D3 of the support substrate 3 (an inside diameter of an upper dummy base body 38C as described later) for a film-forming state. More specifically, where the cylindrical base body 10 at the time of film formation is set in temperature to higher than or equal to 200° C. but lower than or equal to 400° C., then the outside diameter D2 of the insulating shaft member 53 may be set to a value which is greater than the outside diameter D3 of the support substrate 3 (the inside diameter of the following upper dummy base body 38C) by an amount of greater than or equal to 0.1 mm but less than or equal to 5 mm, or more specifically a value which is about 3 mm larger than the outside diameter D3. To fulfill such a condition, the difference between the outside diameter D2 of the insulating shaft member 53 and the outside diameter D3 of the support substrate 3 (the inside diameter of the following upper dummy base body 38C) is set to a value greater than or equal to 0.6 mm but less than or equal to 5.5 mm at the time of non-film formation (room-temperature environment (for example, surroundings at temperatures of 10° C. or above and 40° C. or below).

The insulating flat plate 54 serves to protect the cylindrical base body 10 against adhesion of foreign matter such as dirt or dust fallen from above at the time of detachment of the plate 41, and is shaped in a circular plate having an outside diameter D4 greater than an inside diameter D3 of the upper dummy base body 38C. The diameter D4 of the insulating flat plate 54 may be set to 1.5 or more and 3 or less times the diameter D3 of the cylindrical base body 10, and, for example, in the case of using a component having a diameter D3 of 30 mm for the cylindrical base body 10, the diameter D4 of the insulating flat plate 54 is set to about 50 mm.

The placement of such an insulating flat plate 54 helps suppress abnormal electrical discharge caused by foreign matter which has adhered to the cylindrical base body 10, thus reducing occurrence of film formation failure. This makes it possible to achieve improvement in yield for the production of the electrophotographic photoreceptor 1, as well as to reduce occurrence of image defects in an image-forming process using the electrophotographic photoreceptor 1.

As shown in FIG. 2, the raw material gas supply means 6 comprises: a plurality of raw material gas tanks 60, 61, 62, and 63; a gas tank 64 for exclusive use for the dopant of the photoconductive layer 11b; a plurality of pipings 60A, 61A, 62A, 63A, and 64A; valves 60B, 61B, 62B, 63B, 64B, 60C, 61C, 62C, 63C, and 64C; and a plurality of mass flow controllers 60D, 61D, 62D, 63D, and 64D. Via pipings 65a and 65b and the gas introduction ports 45a and 45b, the raw material gas supply means 6 is connected to the cylindrical electrode 40. The raw material gas tanks 60 to 64 are each filled with B₂H₆ (or PH₃), H₂ (or He), CH₄, or SiH₄, for example. The valves 60B to 64B and 60C to 64C, and the mass flow controllers 60D to 64D serve to adjust the flow rate, the composition, and the gas pressure of each raw material gas component or a gas component for exclusive use for the dopant of the photoconductive layer 11b which are introduced into the vacuum reaction chamber 4. As a matter of course, in the raw material gas supply means 6, the type of gas which is to fill each of the raw material gas tanks 60 to 64 or the number of the plurality of raw material gas tanks 60 to 64 is suitably selected in accordance with the type or the composition of a film which is to be formed on the cylindrical base body 10.

The exhaust means 7 serves to discharge gas present in the vacuum reaction chamber 4 out thereof through the gas discharge ports 42A and 44A, and comprises a mechanical booster pump 71 and a rotary pump 72. The pumps 71 and 72 are operated under control on the basis of the result of monitoring by the pressure gauge 49. That is, in the exhaust means 7, on the basis of the result of monitoring by the pressure gauge 49, the vacuum reaction chamber 4 can be maintained under a vacuum, and the gas pressure in the vacuum reaction chamber 4 can be set to a target value. For example, the vacuum reaction chamber 4 may be set in pressure to higher than or equal to 1 Pa but lower than or equal to 100 Pa.

Such a plasma CVD system 2 allows surface roughening and formation of the photosensitive layer 11 and the surface layer 12 to be performed sequentially, with the interior of the vacuum reaction chamber 4 maintained under a vacuum, by a single system, and, the plasma CVD system 2 exemplifies an electrophotographic photoreceptor manufacturing apparatus comprising a surface roughening section, a charge injection blocking layer-forming section, a photoconductive layer-forming section, and a surface layer-forming section.

(Deposited Film Forming Method)

The following describes a method for forming deposited films using the plasma CVD system 2 with respect to the case of producing the electrophotographic photoreceptor 1 comprising the cylindrical base body 10 whose outer surface has the three-dimensional surface texture as described above, laminated with an amorphous silicon (a-Si) film serving as the photosensitive layer 11, and an amorphous silicon carbide (a-SiC) film and an amorphous carbon (a-C) film serving as the surface layer 12 (refer to FIG. 1).

To begin with, in order to form a deposited film (a-Si film) on the cylindrical base body 10, in the plasma CVD system 2 with the plate 41 removed, the support substrate 3 bearing a plurality of cylindrical base bodies 10 (two cylindrical base bodies 10 in the drawing) is set inside the vacuum reaction chamber 4, with subsequent attachment of the plate 41.

In order to support the two cylindrical base bodies 10 on the support substrate 3, on the flange portion 30, a lower dummy base body 38A, the cylindrical base body 10, an intermediate dummy base body 38B, the cylindrical base body 10, and the upper dummy base body 38C are successively stacked so as to cover a main part of the support substrate 3.

As each of the dummy base bodies 38A to 38C, a component obtained by performing conducting treatment on the surface of a conductive or insulative body is selected in accordance with product application, and yet, under normal circumstances, a component formed as a cylindrical body of a material similar to that used for the cylindrical base body 10 is used.

Here, the lower dummy base body 38A serves to adjust the level of the cylindrical base body 10. The intermediate dummy base body 38B serves to suppress occurrence of film formation failure in the cylindrical base body 10 due to arc discharge arising between the ends of the adjacent cylindrical base bodies 10. Used as the intermediate dummy base body 38B is a component having a length greater than a minimum length required to prevent arc discharge (a length of 1 cm in this exemplification), which has been chamfered at its surface side corner by curved-surface machining operation so as to provide a curvature of 0.5 mm or more, or chamfered at its surface side corner by end grinding operation so that a cut-away portion is 0.5 mm or more in axial length and in depth-wise length as well. The upper dummy base body 38C serves to prevent formation of a deposited film on the support substrate 3 for reduction in occurrence of film formation failure due to accidental separation of a film-forming body settled in a laminated state during film formation. The upper dummy base body 38C is partly projected upward beyond the top of the support substrate 3.

The following steps are to seal the vacuum reaction chamber 4, to operate the rotating means 5 in a manner to rotate the cylindrical base body 10 via the support substrate 3, to heat the cylindrical base body 10, and to subject the vacuum reaction chamber 4 to pressure reduction by the exhaust means 7.

For example, heating of the cylindrical base body 10 is carried out by producing heat under the supply of external electric power to the heater 37. Such a heat-producing action of the heater 37 raises the temperature of the cylindrical base body 10 to a target level. While the temperature of the cylindrical base body 10 is selected in accordance with the type and the composition of a film to be formed on the surface of the cylindrical base body 10, for example, when forming an amorphous silicon (a-Si) film, the temperature is adjusted to be higher than or equal to 250° C. but lower than or equal to 300° C., and, the temperature is maintained substantially constant by ON-OFF operation of the heater 37.

Meanwhile, pressure reduction in the vacuum reaction chamber 4 is carried out by discharging gas out of the vacuum reaction chamber 4 through the gas discharge ports 42A and 44A by the exhaust means 7. The level of pressure reduction in the vacuum reaction chamber 4 may be adjusted to about 10⁻³ Pa by controlling the operation of the mechanical booster pump 71 (refer to FIG. 2) and the rotary pump 72 (refer to FIG. 2) while monitoring the pressure in the vacuum reaction chamber 4 by the pressure gauge 49 (refer to FIG. 2).

Next, upon the temperature of the cylindrical base body 10 and the pressure in the vacuum reaction chamber 4 reaching their respective desired levels, a raw material gas is fed into the vacuum reaction chamber 4 by the raw material gas supply means 6, and also DC voltage in pulse form is applied between the cylindrical electrode 40 and the support substrate 3. Consequently, glow discharge occurs between the cylindrical electrode 40 and the support substrate 3 (the cylindrical base body 10) with consequent decomposition of the raw material gas, and, components resulting from the raw material gas decomposition are deposited on the surface of the cylindrical base body 10.

Meanwhile, in the exhaust means 7, the gas pressure in the vacuum reaction chamber 4 is maintained within a target range by controlling the operation of the mechanical booster pump 71 and the rotary pump 72 while performing monitoring by the pressure gauge 49. That is, the interior of the vacuum reaction chamber 4 is maintained under a stable gas pressure by the mass flow controllers 60D to 63D of the raw material gas supply means 6 and the pumps 71 and 72 of the exhaust means 7. For example, a gas pressure of the vacuum reaction chamber 4 may be set to higher than or equal to 1 Pa but lower than or equal to 100 Pa.

Feed of raw material gases into the vacuum reaction chamber 4 is carried out by introducing raw material gases stored in the raw material gas tanks 60 to 64, through the pipings 60A to 64A, the pipings 65a and 65b, and the gas introduction ports 45a and 45b, into the cylindrical electrode 40, with their compositions and flow rates adjusted to the desired levels, by controlling the mass flow controllers 60D to 64D while exercising suitable control over the opening and closing of the valves 60B to 64B and 60C to 64C. The introduced raw material gas within the cylindrical electrode 40 is blown out toward the cylindrical base body 10 through the plurality of gas outlet holes 46. By making suitable changes to the composition of the raw material gas by the valves 60B to 64B and 60C to 64C and the mass flow controllers 60D to 64D, the charge injection blocking layer 11a, the photoconductive layer 11b, and the surface layer 12 are formed one after another on the surface of the cylindrical base body 10.

Application of DC voltage in pulse form between the cylindrical electrode 40 and the support substrate 3 is carried out by operating the DC power supply 34 under the control of the control section 35.

In the case of utilizing high-frequency power in a RF (Radio Frequency) band of frequencies ranging upwardly from 13.56 MHz, ion species generated in a space are accelerated by an electric field so as to be attracted in directions corresponding to positive polarity and to negative polarity, and yet, at this time, due to consecutive reversals of the electric field under high-frequency AC, the ion species undergo recombination repeatedly in the space before reaching the cylindrical base body 10 or a discharge electrode, and are thus discharged in gaseous form or the form of a silicon compound such as polysilicon powder over and over.

In contrast, in the case of forming an amorphous silicon (a-Si) film through sputtering for fine surface asperities using the impact of impingement of cation in an accelerated state upon the cylindrical base body 10 under application of DC voltage in pulse form so as to impart one of positive and negative polarities to the cylindrical base body 10-side area, amorphous silicon (a-Si) having a surface with a highly uniform distribution of asperities achieved by inhibition of the growth of appreciable protuberant points is obtained. In what follows, such a phenomenon may also be referred to as “ion sputtering effect”.

In order to effectively obtain the ion sputtering effect in such a plasma CVD method, it is necessary to apply such power as to avoid consecutive reversals of polarities, and, in this regard, in addition to the above-described pulse-like rectangular waves, triangular waves and polarity reversal-free DC voltage are also useful. Similar effects can be attained with use of AC voltage adjusted so that each and every voltage has any one of positive and negative polarities. The polarity of applied voltage can be adjusted freely with consideration given to, for example, the rate of film formation which is determined by the density of ion species, the polarities of deposited species, etc., depending on the type of the raw material gas.

Here, in order to effectively obtain the ion sputtering effect by pulse-like voltage, the difference in potential between the support substrate 3 (the cylindrical base body 10) and the cylindrical electrode 40 is greater than or equal to 50 V but less than or equal to 3000 V for example, or more specifically greater than or equal to 500 V but less than or equal to 3000 V with consideration given to the rate of film formation.

More specifically, where the cylindrical electrode 40 is grounded, the control section 35 feeds a negative pulse-like DC potential V1 within the range of −3000 V or more and −50 V or less, or a positive pulse-like DC potential V1 within the range of 50 V or more and 3000 V or less, to the support substrate (the conductive support column 31).

On the other hand, where the cylindrical electrode 40 is connected to a reference electrode (not shown), the pulse-like DC potential V1 to be fed to the support substrate (the conductive support column 31) takes on the value of a difference between a target potential difference AV and a potential V2 fed from the reference power supply (ΔV−V2). The potential V2 fed from the reference power supply is greater than or equal to −1500 V but less than or equal to 1500 V in the case of applying a negative pulse-like voltage to the support substrate 3 (the cylindrical base body 10), and is greater than or equal to −1500 V but less than or equal to 1500 V in the case of applying a positive pulse-like voltage to the support substrate 3 (the cylindrical base body 10).

Moreover, the control section 35 controls the DC power supply 34 so as to adjust a frequency of DC voltage (1/T (sec)) to be less than or equal to 300 kHz, and adjust a duty ratio (T1/T) to be greater than or equal to 20% but less than or equal to 90%.

The duty ratio as employed in this embodiment is defined as the time ratio representing the proportion of potential difference generation time T1 based on one period of pulse-like DC voltage (T) (the time which expires between the moment at which a potential difference has occurred between the cylindrical base body 10 and the cylindrical electrode 40 and the moment at which the following potential difference has occurred). For example, the duty ratio of 20% means that the potential difference generation (ON) time occupied in one period when applying pulse-like voltage constitutes 20% of the entire one period.

The amorphous silicon (a-Si)-made photoconductive layer 11b obtained with utilization of the ion sputtering effect has, even if its thickness is 10 μm or greater, a surface with a highly uniform distribution of asperities achieved by inhibition of the growth of appreciable protuberant points as described above. Hence, on the photoconductive layer lib, there is provided a stack of amorphous silicon carbide (a-SiC) and amorphous carbon (a-C) in a total of about 1 μm as the surface layer 12. In this case, the surface profile of the surface layer 12 can be made as a reflection of the surface profile of the photoconductive layer 11b. That is, also in the case of laminating the surface layer 12 on the photoconductive layer 11b, the utilization of the ion sputtering effect renders the surface layer 12 a film having a highly uniform distribution of surface asperities achieved by inhibition of the growth of appreciable protuberant points.

At this time, as described above, in forming the charge injection blocking layer 11a, the photoconductive layer 11b, and the surface layer 12, the mass flow controllers 60D to 63D of the raw material gas supply means 6 and the valves 60B to 63B and 60C to 63C are controlled so that a raw material gas of target composition can be fed into the vacuum reaction chamber 4.

For example, in the case of forming the charge injection blocking layer 11a as an amorphous silicon (a-Si) deposited film, used as the raw material gas is a gas mixture of silicon (Si)-containing gas such as SiH₄ (silane gas), a dopant-containing gas such as B₂H₆ or PH₃, and diluent gas such as hydrogen (H₂) or helium (He). Used as the dopant-containing gas is a raw material gas composed of boron (B)-containing gas and, on an as needed basis, nitrogen (N)-containing gas or oxygen (O)-containing gas, or both of them, or a material gas composed of phosphorus (P)-containing gas and, on an as needed basis, nitrogen (N)-containing gas or oxygen (O)-containing gas, or both of them.

In the case of forming the photoconductive layer 11b as an amorphous silicon (a-Si) deposited film, used as the raw material gas is a gas mixture of silicon (Si)-containing gas such as SiH₄ (silane gas) and diluent gas such as hydrogen (H₂) or helium (He). In forming the photoconductive layer 11b, it is advisable to use hydrogen gas as diluent gas, or to add a halide content to the raw material gas, in a manner whereby hydrogen (H) or halogen elements (fluorine (F) and chlorine (Cl)) can be contained in the film in an amount of greater than or equal to 1% by atom but less than or equal to 40% by atom for dangling-bond termination purposes. Moreover, the raw material gas may be given a content of elements belonging to Groups 12 and 13 in the periodic table of the elements (hereafter abbreviated to “Group 12 element” and “Group 13 element”) or elements belonging to Groups 15 and 16 in the periodic table of the elements (hereafter abbreviated to “Group 15 element” and “Group 16 element”) as a dopant to attain desired characteristics as to electrical properties such as dark conductivity and photoconductivity, and optical band gap, and may also be given a content of elements such as carbon (C) and oxygen (O) for adjustment of the above-described characteristics.

For example, boron (B) and phosphorus (P) are desirable for use as Group 13 element and Group 15 element, respectively, in that each element is capable of changing semiconductor characteristics sensitively with its excellence in covalent bonding and also providing excellent light sensitivity. In cases where Group 13 element or Group 15 element is contained together with other elements such as carbon (C) and oxygen (O) in forming the charge injection blocking layer 11a, the content of Group 13 element is adjusted to be greater than or equal to 0.1 ppm but less than or equal to 20000 ppm, and the content of Group 15 element is adjusted to be greater than or equal to 0.1 ppm but less than or equal to 10000 ppm. Moreover, in cases where Group 13 element or Group 15 element is contained together with other elements such as carbon (C) and oxygen (O) in forming the photoconductive layer 11b, or where the elements such as carbon (C) and oxygen (O) are not contained in forming the charge injection blocking layer 11a and the photoconductive layer 11b, then the content of Group 13 element is adjusted to be greater than or equal to 0.01 ppm but less than or equal to 200 ppm, and the content of Group 15 element is adjusted to be greater than or equal to 0.01 ppm but less than or equal to 100 ppm. Element concentration gradients may be provided in the layer thickness direction by changing the content of Group 13 element or Group 15 element in the raw material gas over time. In this case, the content of Group 13 element or Group 15 element in the photoconductive layer 11b is determined so that the average content of the element throughout the whole of the photoconductive layer 11b falls within the specified range.

Moreover, the photoconductive layer 11b may be formed of an amorphous silicon (a-Si)-based material containing microcrystalline silicon (μc-Si). In the case where the microcrystalline silicon (μc-Si) is contained, dark conductivity and photoconductivity can be increased, and therefore there is an advantage to afford greater design flexibility for the photoconductive layer 11b. Such a microcrystalline silicon (μc-Si) can be formed by adopting the earlier described film-forming method and changing film formation conditions. For example, in the glow-discharge decomposition method, microcrystalline silicon can be formed in conditions where the temperature of the cylindrical base body 10 and DC pulse power are each set at a relatively high level, and the flow rate of hydrogen serving as diluent gas is increased. Moreover, also in the case where the photoconductive layer 11b contains microcrystalline silicon (μc-Si), elements similar to those as above described (Group 13 element, Group 15 element, carbon (C), oxygen (O), etc.) may be added therein.

As described above, the surface layer 12 is configured to have a multilayer structure composed of a-SiC and a-C layers. In this case, used as the raw material gas are silicon (Si)-containing gas such as SiH₄ (silane gas), and C-containing gas such as C₂H₂ (acetylene gas) or CH₄ (methane gas). The a-C layer constituting the third layer of the surface layer 12 is set in film thickness to greater than or equal to 0.01 μm but less than or equal to 2 μm, or specifically greater than or equal to 0.02 μm but less than or equal to 1 μm, or more specifically greater than or equal to 0.03 μm but less than or equal to 0.8 μm, under normal circumstances. Moreover, the surface layer 12 is set in film thickness to greater than or equal to 0.1 μm but less than or equal to 6 μm, or specifically greater than or equal to 0.25 μm but less than or equal to 3 μm, or more specifically greater than or equal to 0.4 μm but less than or equal to 2.5 μm, under normal circumstances.

In the case where the surface layer 12 is formed to have the a-C layer as the third layer, due to C—O bond being smaller in bond energy than Si—O bond, as contrasted to a case where the surface layer 12 is formed solely of an amorphous silicon (a-Si)-based material, oxidation of the surface of the surface layer 12 can be suppressed more reliably. Hence, by forming the third layer of the surface layer 12 as the amorphous carbon (a-C) layer, it is possible to properly suppress oxidation of the surface of the surface layer 12 by, for example, ozone generated in corona discharge during printing operation, and thereby reduce occurrence of image deletion in an environment at high temperature and with high humidity, for example.

Following the completion of film formation on the cylindrical base body 10 in the above-described manner, the cylindrical base body 10 is removed from the support substrate 3, whereupon the electrophotographic photoreceptor 1 as shown in FIG. 1 is obtained. After the film formation, in order to remove the deposition residues, the assembly within the vacuum reaction chamber 4 is disassembled to subject the individual members to cleaning such as acid cleaning, alkali cleaning, or blast cleaning, with subsequent wet etching being effected to avoid dust production which may cause defects or failure in the following image-forming process. Instead of wet etching, it is also effective to perform gas etching using halogen gas (CIF₃, CF₄, NF₃, SiF₆, or a mixture of these gases).

(Image Forming Apparatus)

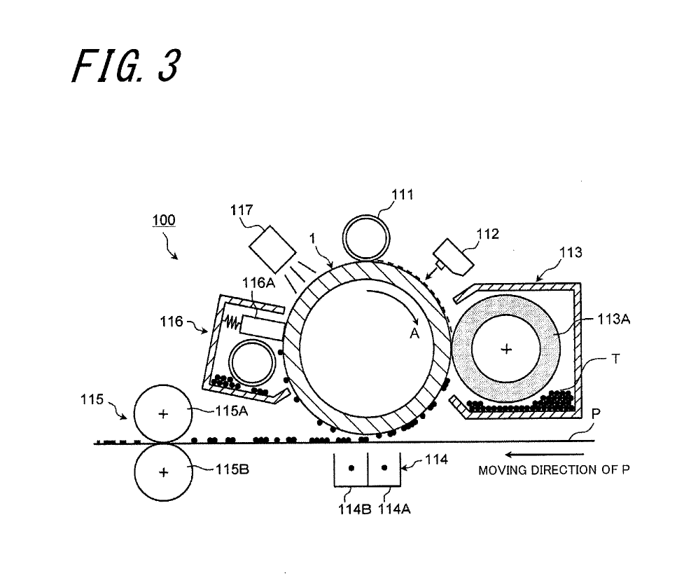

A method of manufacturing an image forming apparatus according to an embodiment of the invention will be described with reference to FIG. 3.

The image forming apparatus shown in FIG. 3 adopts the Carlson process as an image forming system, and comprises: the electrophotographic photoreceptor 1; a charging device 111; an exposure device 112; a developing device 113; a transfer device 114; a fixing device 115; a cleaning device 116; and a charge-eliminating device 117.

The charging device 111 serves to charge the surface of the electrophotographic photoreceptor 1 negatively. A charged voltage is set to greater than or equal to 200 V but less than or equal to 1000 V, for example. Although this embodiment adopts, as the charging device 111, for example, a contact-type charging device configured by coating a core bar with a conductive rubber or PVDF (polyvinylidene fluoride), a non-contact type charging device provided with a discharge wire (for example, a corona charger) may be adopted instead.

The exposure device 112 serves to form an electrostatic latent image on the electrophotographic photoreceptor 1. More specifically, the exposure device 112 forms an electrostatic latent image by applying exposure light of specific wavelength (for example, greater than or equal to 650 nm but less than or equal to 780 nm) such for example as laser light to the electrophotographic photoreceptor 1 according to an image signal so as to attenuate the potential at a part of the electrophotographic photoreceptor 1 in a charged state which is irradiated with the exposure light. As the exposure device 112, for example, it is possible to adopt an LED (Light Emitting Diode) head composed of an arrangement of a plurality of LED elements (wavelength: 680 nm).

As a matter of course, instead of the LED element, those capable of laser light emission can be used as the light source of the exposure device 112. That is, an optical system comprising a polygon mirror can be used in place of the exposure device 112 such as the LED head, for example. In another alternative, by adopting an optical system comprising a lens through which light reflected from an original document passes and a mirror, the image forming apparatus can be built as a copying machine.

The developing device 113 serves to form a toner image by developing the electrostatic latent image borne on the electrophotographic photoreceptor 1. The developing device 113 in this example provided with a magnetic roller 113A for magnetically retaining a developer (toner) T.

The developer T constitutes the toner image formed on the surface of the electrophotographic photoreceptor 1, and is frictionally charged in the developing device 113. Examples of the developer T include a two-component developer comprising a magnetic carrier and an insulating toner and a single-component developer comprising a magnetic toner.

The magnetic roller 113A serves to convey the developer to the surface (development region) of the electrophotographic photoreceptor 1. The magnetic roller 113A conveys the developer T frictionally charged in the developing device 113 in the form of a magnetic brush adjusted to a constant length. In the range of the development region of the electrophotographic photoreceptor 1, the conveyed developer T adheres to the surface of the electrophotographic photoreceptor 1 under the electrostatic attractive force with respect to the electrostatic latent image so as to form a toner image (visualize the electrostatic latent image). The charging polarity of the toner image is the reverse of the charging polarity of the surface of the electrophotographic photoreceptor 1 when performing image formation in accordance with the charged area development, and is yet identical with the charging polarity of the surface of the electrophotographic photoreceptor 1 when performing image formation in accordance with the reversal development.

With respect to the developing device 113, although the dry development system is adopted in this example, the wet development system using a liquid developer may be adopted instead.

The transfer device 114 serves to transfer the toner image borne on the electrophotographic photoreceptor 1 onto a recording medium P which has been fed to a transfer region between the electrophotographic photoreceptor 1 and the transfer device 114. The transfer device 114 in this example is provided with a transfer charger 114A and a separation charger 114B. In the transfer device 114, the back side (non-recording side) of the recording medium P is charged to a polarity reverse to that of the toner image by the transfer charger 114A, and, under the electrostatic attractive force exerted between the resultant charge and the toner image, the toner image is transferred onto the recording medium P. Moreover, in the transfer device 114, the back side of the recording medium P is subjected to AC charging in the separation charger 114B concurrently with the toner image transfer, thus causing the recording medium P to move away from the surface of the electrophotographic photoreceptor 1 swiftly.

As the transfer device 114, it is also possible to use a transfer roller which is rotatable in response to the rotation of the electrophotographic photoreceptor 1 and is spaced a minute distance (for example, a spacing of less than or equal to 0.5 mm) away from the electrophotographic photoreceptor 1. The transfer roller is configured to apply such a transfer voltage as to attract the toner image borne on the electrophotographic photoreceptor 1 onto the recording medium P by a DC power supply, for example. In the case of using the transfer roller, a transfer separation device such as the separation charger 114B may be omitted from the construction.

The fixing device 115 serves to fix the toner image transferred on the recording medium P on the recording medium P, and comprises a pair of fixing rollers 115A and 115B. For example, the fixing rollers 115A and 115B are each configured by applying a surface coating of, for example, tetrafluoroethylene onto a metallic roller. In the fixing device 115, the recording medium P passes through a space between the pair of fixing rollers 115A and 115B under application of heat, pressure, etc., so that the toner image can be fixed on the recording medium P.

The cleaning device 116 serves to remove the toner remaining on the surface of the electrophotographic photoreceptor 1, and comprises a cleaning blade 116A. The cleaning blade 116A serves to scrape the residual toner off the surface of the electrophotographic photoreceptor 1. For example, the cleaning blade 116A is formed of a rubber material predominantly composed of polyurethane resin.

The charge-eliminating device 117 serves to remove surface charge on the electrophotographic photoreceptor 1, and is capable of emitting light of specific wavelength (for example, a wavelength of greater than or equal to 780 nm). The charge-eliminating device 117 is configured to remove surface charge (residual electrostatic latent image) on the electrophotographic photoreceptor 1 by applying light to the entire axial area of the surface of the electrophotographic photoreceptor 1 by a light source such for example as an LED.

The method of manufacturing the image forming apparatus 100 of the embodiment is a method further including a step of installing the cleaning device 116 in contact with the surface of the electrophotographic photoreceptor 1 in addition to the above-described method of manufacturing the electrophotographic photoreceptor 1, and may include a step of installing other devices such as the charging device 111, the exposure device 112, the developing device 113, the transfer device 114, the fixing device 115, and the charge-eliminating device 117.

The image forming apparatus 100 according to this embodiment can provide the above-described advantageous effects achieved by the electrophotographic photoreceptor 1.

### EXAMPLES

The electrophotographic photoreceptor in accordance with the embodiment of the invention was evaluated in the following manner.

Production of Electrophotographic Photoreceptor 1

<Cylindrical Base Body 10>

The cylindrical base body 10 was produced from an aluminum alloy-made metal tube (30 mm in outside diameter, 360 mm in length). The outer periphery of the cylindrical base body 10 was subjected to mirror finishing, wet blasting, and cleaning.

In the first place, as a mirror finishing process of the surface of the cylindrical base body 10, with the cylindrical base body 10 retained at both ends, a diamond turning tool was pressed against the cylindrical base body 10 in a state of high speed rotation of 1500 to 8000 rpm and the burnishing process was performed at the feed rate of 0.08 to 0.5 mm. That is, as the finishing face of the turning tool, the diamond turning tool which extends deep in a work turning direction was pressed against the surface of the cylindrical base body 10 to obtain a smooth-finished surface.

After such a mirror finishing process, the cylindrical base body 10 was subjected to degreasing cleaning.

Next, as a wet blasting process, surface roughening was performed by mixing and accelerating a mixture obtained by stirring a super-hard abrasive material such as alumina and water, with compressed air and shooting the mixture toward the mirror-finished surface of the cylindrical base body 10. In this way, by performing working operation while rotating the cylindrical base body 10, it is possible to form a worked surface in a short period of time. As in this example, according to the wet blasting process, as contrasted to other working process, uniform shots of abrasives having a small particle size can be relatively easily made, wherefore a worked surface with high uniformity can be obtained.

More specifically, 15 samples of the cylindrical base body 10 having different surfaces were prepared by making adjustments to the following parameters as wet blasting conditions.

Type and particle size of abrasive material: A (Alundum (brown fused alumina)) #320 to #400

Concentration of abrasives: 10 to 18%

Shot air pressure: 0.10 to 0.35 MPa

Shot distance (distance between work center and blasting head): 20 to 300 mm

Shot time: 1 to 60 seconds

Number of work revolutions: 120 to 180 rpm

Adjustment of Sal value was made by adopting different abrasive materials and different particle sizes, and adjustment of Str value was made by varying the shot air pressure, the shot distance, and the shot time (1 to 60 seconds).

After the wet blasting process, residues remaining on the surface was removed by cleaning, whereupon the preparation of 15 kinds of cylindrical base bodies 10 having the surface conditions shown in Table 1 was completed.

TABLE 1

Surface conditions of cylindrical
base body after roughening

| Sample No. | Str | Sal [μm] |
|---|---|---|
| 1 | 0.62 | 0.3 |
| 2 | 0.70 | 0.3 |
| 3 | 0.80 | 0.3 |
| 4 | 0.62 | 0.7 |
| 5 | 0.70 | 0.8 |
| 6 | 0.80 | 0.6 |
| 7 | 0.62 | 3.1 |
| 8 | 0.70 | 3.1 |
| 9 | 0.80 | 3.1 |
| 10 | 0.62 | 8.2 |
| 11 | 0.70 | 8.4 |
| 12 | 0.80 | 8.2 |
| 13 | 0.62 | 12.3 |
| 14 | 0.70 | 12.6 |
| 15 | 0.80 | 12.6 |

The cylindrical base body 10 thereby prepared was set in the plasma CVD system as shown in FIG. 2, and then, the charge injection blocking layer 11a, the photoconductive layer 11b, and the surface layer 12 were formed on the surface of the cylindrical base body 10 in conditions as listed in Table 2.

TABLE 2

| | | | | Surface layer | | |
|---|---|---|---|---|---|---|
| | | Charge injection | Photoconductive | | Second | |
| Layer type | | blocking layer | layer | First layer | layer | Third layer |
| Gas type | SiH4 (sccm) | 170 | 340 | 30 | 6 | |
| | H2 (sccm) | 200 | 200 | — | — | — |
| | B2H6* | 0.10% | 0.3 ppm | — | — | — |
| | CH4 (sccm) | — | — | 600 | 600 | 600 |
| | NO* | 10% | — | — | — | — |

| | | | | | |
|---|---|---|---|---|---|
| Pressure (Pa) | 60 | 60 | 60 | 60 | 60 |
| Base body temperature | 300 | 300 | 250 | 250 | 250 |
| (° C.) | | | | | |
| DC voltage (V) | −900 | −1000 | −400 | −400 | −400 |
| Pulse frequency (KHz) | 50 | 50 | 50 | 50 | 50 |
| Duty ratio (%) | 70 | 70 | 70 | 70 | 70 |
| Film thickness (μm) | 5 | 14 | 0.3 | 0.7 | 0.2 |

*Ratio of B2H6/NO flow rate to SiH4 flow rate

In Table 2, the flow rates of B₂H₆ gas and NO gas are given in terms of ratio, namely the ratio of B₂H₆/NO flow rate to SiH₄ flow rate. Used as the power supply of the plasma CVD system was a DC pulse power supply (pulse frequency: 50 kHz, Duty ratio: 70%). Moreover, film thickness measurement was performed by analyzing the section of each film with SEM (scanning electron microscope) and XMA (X-ray microanalyzer). The following describes the specific structure of each layer.

<Charge Injection Blocking Layer>

The charge injection blocking layer 11a is formed of an amorphous silicon (a-Si)-based material which includes amorphous silicon (a-Si) with nitrogen (N) and oxygen (O) added, and also contains boron (B) as a dopant.

The film thickness of the charge injection blocking layer 11a was set to 5 μm.

<Photoconductive Layer>

The photoconductive layer 11b is formed of an amorphous silicon (a-Si)-based material which includes amorphous silicon (a-Si) with carbon (C), nitrogen (N), oxygen (O), etc. added, and also contains boron (B) as a dopant.

The film thickness of the photoconductive layer 11b was set to 14 μm.

<Surface Layer>

The surface layer 12 is composed of a stack of amorphous silicon carbide (a-SiC) and amorphous carbon (a-C).

The surface layer 12 was set in total film thickness to 1.2 μm, and, the third layer of the surface layer was set in film thickness to 0.2 μm.

Then, Sample Nos. 1 to 15 of the electrophotographic photoreceptor 1 were produced while causing variations in the surface roughness of the surface layer 12.

In each of Sample Nos. 1 to 15 of the electrophotographic photoreceptor 1 thus obtained, the surface texture of the surface layer 12 was measured.

The measurement was made by LEXT OLS-4100 3D Measuring Laser Microscope manufactured by Olympus Corporation, and each surface texture has been evaluated on the basis of ISO 25178-compliant three-dimensional surface roughness parameters. As measurement conditions, a lens with 50-fold magnification was used, and an area of 260 μm by 261 μm was measured in a fast measurement mode. Due to the measurement target having a cylindrical shape, as a correcting process, X-Y direction curvature correction was conducted. In addition, filtering correction was run at a center wavelength λc of 0.080 mm to eliminate the influence of periodic seams in machining operation, and each parameter was determined by calculation. Note that the result of measurement corresponds to the arithmetic mean of the data on 5 locations within a 100 mm-range of the central area of the cylindrical base body 10 of the electrophotographic photoreceptor 1 in the axial direction.

The values of Str and Sal in each sample are listed in Table 3 as described later.

Next, each of the thereby produced samples of the electrophotographic photoreceptor 1 was incorporated in a remodeling apparatus of the color multifunction printer TASKalfa 3550ci manufactured by KYOCERA Document Solutions Inc., and, each sample was evaluated for: the rate of Sa decrease (%) at the surface layer 12 of the electrophotographic photoreceptor 1 as obtained upon completion of continuous printing of 600000 (600 K) copies; signs of flaws in the cleaning blade 116A serving as a peripheral member for the electrophotographic photoreceptor 1; and image characteristic determined by observation of contamination at the surface of the charging roller. Then, comprehensive evaluation was made on the basis of the result of evaluation for each of the individual characteristics.

The above-described individual characteristics were evaluated under the following conditions. That is, in an evaluation environment at room temperature set at 23° C. and with relative humidity set at 60%, evaluation was performed by measurement of the surface condition of the electrophotographic photoreceptor 1 using the above-described laser microscope; examination for the presence of a flaw at the edge part of the cleaning blade 116A; and observation of contamination at the surface of the charging roller under a magnifying glass (20-fold magnification) at each of the time of completion of continuous printing of 200000 copies, the time of completion of continuous printing of 400000 copies, and the time of completion of continuous printing of 600000 copies.

As employed herein, the rate of Sa decrease (%) refers to the percentage of a decrease in the value of Sa at the surface layer 12 of the electrophotographic photoreceptor 1 from the before-printing initial value. For example, a description of “70%” means that Sa value equals 30% of the before-printing initial value. In Table 3, in the data of the rate of Sa decrease (%), the value denoted by an asterisk indicates the rate of Sa decrease (%) at the surface layer 12 of the electrophotographic photoreceptor 1 as obtained upon completion of continuous printing of 200000 (200 K) copies.

Moreover, modes of damage to the cleaning blade have been classified as follows. The sample rated “A” showed signs of slight damage to the cleaning blade upon completion of continuous printing of 200000 (200 K) copies. On the other hand, the sample rated “B” showed signs of appreciable damage to the cleaning blade upon completion of printing of only 1000 copies or fewer.

Table 3 provides a listing of evaluation results.

TABLE 3

| | Surface conditions | | Individual characteristics | | | | |
|---|---|---|---|---|---|---|---|
| | of cylindrical base | | Sa reduction | | | | |
| | body after | | rate after | | | | |
| Sample | roughening | | standing 600k | Blade | Breakage | Image | Comprehensive |
| No. | Str | Sal [μm] | printing [%] | breakage | mode | characteristics | evaluation |
| 1 | 0.62 | 0.3 | 64* | Poor | A | Available | Available |
| 2 | 0.70 | 0.3 | 65* | Available | A | Good | Good |
| 3 | 0.80 | 0.3 | 68* | Available | A | Good | Good |
| 4 | 0.62 | 0.7 | — | Poor | B | Available | Available |
| 5 | 0.70 | 0.8 | 70 | Excellent | — | Excellent | Excellent |
| 6 | 0.80 | 0.6 | 76 | Excellent | — | Excellent | Excellent |
| 7 | 0.62 | 3.1 | — | Poor | B | Available | Available |
| 8 | 0.70 | 3.1 | 57 | Good | — | Excellent | Excellent |
| 9 | 0.80 | 3.1 | 66 | Excellent | — | Excellent | Excellent |
| 10 | 0.62 | 8.2 | — | Poor | B | Poor | Poor |
| 11 | 0.70 | 8.4 | 45 | Good | — | Excellent | Excellent |
| 12 | 0.80 | 8.2 | 54 | Good | — | Excellent | Excellent |
| 13 | 0.62 | 12.3 | — | Poor | B | Poor | Poor |
| 14 | 0.70 | 12.6 | — | Poor | B | Poor | Poor |
| 15 | 0.80 | 12.6 | — | Poor | B | Poor | Poor |

In Table 3, “Excellent” indicates possession of excellent characteristics, “Good” indicates possession of preferable characteristics, “Available” indicates possession of characteristics of required level, and “Poor” indicates insufficiency of characteristics of required level.

That is, the data given in Table 3 has led to the following findings.

Except for cases where initial failure has occurred due to Sal value after wet blasting process (roughening step) (Sample Nos. 14 and 15), the electrophotographic photoreceptor 1 achieves advantageous effects where the value of Str after the roughening step is greater than or equal to 0.70 (Sample Nos. 2, 3, 5, 6, 8, 9, 11 and 12). More advantageous effects can be attained where the value of Str after the roughening step is greater than or equal to 0.80, in particular (Sample Nos. 3, 6, 9 and 12).

The experimental data has showed that, where Str after the roughening step is greater than or equal to the predetermined value, the surface of the surface layer 12 can have a highly uniform distribution of asperities, and therefore the surface roughness can be maintained within a certain range even if the surface becomes worn gradually during prolonged usage. This allows for continued reduction of an increase in frictional resistance between the surface layer 12 and the cleaning blade 116A effectively. Due presumably to this effect, the cleaning blade 116A can be restrained from chipping off, with consequent reduction in image defects such as appearance of an unusual stripe on a printed image. As described above, according to the embodiment, by roughening the outer surface of the cylindrical base body 10 to a predetermined surface roughness, the characteristics can be improved without roughening the surface of the layers formed on the outer surface of the cylindrical base body 10 (photosensitive layer and surface layer), thereby realizing excellent durability characteristics and low image defects. The cause for occurrence of initial failure in Sample Nos. 14 and 15 is believed to be chipping damage to the cleaning blade 116A resulting from an increase in frictional resistance between the surface layer 12 of the electrophotographic photoreceptor 1 and a peripheral member such as the cleaning blade 116A as observed when Sal after the roughening step takes on a large value.

Moreover, the following has been found to hold so long as the value of Str after the roughening step is greater than or equal to 0.70. That is, where the value of Sal after the roughening step is less than or equal to 8.4 μm (Sample Nos. 2, 3, 5, 6, 8, 9, 11 and 12), advantageous effects can be attained. The relevant experimental data has showed that, where Sal after the roughening step is less than the predetermined value, the frictional resistance between the surface layer 12 of the electrophotographic photoreceptor 1 and the cleaning blade 116A can be reduced, wherefore the cleaning blade 116A can be restrained from chipping off, which leads to excellent enduring characteristics. On the other hand, where the value of Sal after the roughening step is greater than or equal to 0.3 μm (Sample Nos. 2, 3, 5, 6, 8, 9, 11 and 12), advantageous effects can be attained. Moreover, where the value of Sal after the roughening step is greater than or equal to 0.6 μm (Sample Nos. 5, 6, 8, 9, 11 and 12), more advantageous effects can be attained. The relevant experimental data has showed that, where Sal is greater than the predetermined value, wear of the surface layer 12 of the electrophotographic photoreceptor 1 can be reduced, and the cleaning blade 116A can thus be restrained from chipping off, which leads to excellent enduring characteristics.

It is needless to say that the invention is not limited to the above-described embodiments, and thus various changes and modifications are possible without departing from the scope of the invention.

For example, in the above-described embodiments, the cylindrical base body 10, the charge injection blocking layer 11a, and the photoconductive layer 11b have been illustrated as separate constituent elements, however, in the alternative, the cylindrical base body 10 may be configured so that at least a surface thereof has charge injection blocking characteristics. In this case, the cylindrical base body 10 in itself becomes capable of blocking injection of carriers (electrons) into the photoconductive layer 11b from the cylindrical base body 10 without the necessity of providing the charge injection blocking layer 11a independently.

### REFERENCE SIGNS LIST

1: Electrophotographic photoreceptor

2: Plasma CVD system

3: Support substrate

4: Vacuum reaction chamber

5: Rotating means

6: Raw material gas supply means

7: Exhaust means

10: Cylindrical base body

11: Photosensitive layer

11a: Charge injection blocking layer

11b: Photoconductive layer

12: Surface layer

30: Flange portion

31: Conductive support column

32: Insulating material

33: Conducting plate

34: DC power supply

35: Control section

36: Ceramic pipe

37: Heater

38: Dummy base body

38A: Lower dummy base body

38B: Intermediate dummy base body

38C: Upper dummy base body

40: Cylindrical electrode

41, 42: Plate

43, 44: Insulating member

42A, 44A: Gas discharge port

45a, 45b: Gas introduction port

46: Gas outlet hole

49: Pressure gauge

50: Rotary motor

51: Rotational force transmitting mechanism

52: Rotation-introducing terminal

53: Insulating shaft member

54: Insulating flat plate

60-63: Raw material gas tank

64: Gas tank for exclusive use for dopant

60A-64A, 65a, 65b: Piping

60B-64B, 60C-64C: Valve

60D-64D: Mass flow controller

71: Mechanical booster pump

72: Rotary pump

100: Image forming apparatus

111: Charging device

112: Exposure device

113: Developing device

113A: Magnetic roller

114: Transfer device

114A: Transfer charger

114B: Separation charger

115: Fixing device

115A, 115B: Fixing roller

116: Cleaning device

117: Charge-eliminating device

P: Recording medium

T: Developer

1. A method of manufacturing an electrophotographic photoreceptor, comprising:
a step of roughening an outer surface of a cylindrical base body so that a surface roughness of the outer surface of the cylindrical base body satisfies Str≥0.70, in which Str denotes texture aspect ratio;
a step of forming a charge injection blocking layer on the outer surface of the cylindrical base body;
a step of forming a photoconductive layer on the charge injection blocking layer; and
a step of forming a surface layer on the photoconductive layer.

2. The method of manufacturing an electrophotographic photoreceptor according to claim 1, further comprising:
a step of mirror finishing the outer surface of the cylindrical base body before the step of roughening.

3. The method of manufacturing an electrophotographic photoreceptor according to claim 2, wherein the surface roughness of the outer surface of the cylindrical base body satisfies Sa<30 nm and Sz<2 μm in a state where the step of mirror finishing has been performed, in which Sa denotes arithmetic mean roughness and Sz denotes maximum height.

4. The method of manufacturing an electrophotographic photoreceptor according to claim 1, wherein the surface roughness of the outer surface of the cylindrical base body satisfies Str≥0.80 in a state where the step of roughening has been performed.

5. The method of manufacturing an electrophotographic photoreceptor according to claim 1, wherein the surface roughness of the outer surface of the cylindrical base body satisfies Sal≤8.4 μm in a state where the step of roughening has been performed, in which Sal denotes shortest autocorrelation length.

6. The method of manufacturing an electrophotographic photoreceptor according to claim 1, wherein the surface roughness of the outer surface of the cylindrical base body satisfies Sal≥0.3 μm in a state where the step of roughening has been performed, in which Sal denotes shortest autocorrelation length.

7. The method of manufacturing an electrophotographic photoreceptor according to claim 1, wherein the surface roughness of the outer surface of the cylindrical base body satisfies Sal≥0.6 μm in a state where the step of roughening has been performed, in which Sal denotes shortest autocorrelation length.

8. The method of manufacturing an electrophotographic photoreceptor according to claim 1, wherein at least one layer of the charge injection blocking layer, the photoconductive layer and the surface layer includes amorphous silicon (a-Si).

9. The method of manufacturing an electrophotographic photoreceptor according to claim 1, wherein the step of roughening is performed by wet blasting.

10. The method of manufacturing an electrophotographic photoreceptor according to claim 1, wherein the step of forming the charge injection blocking layer, the step of forming the photoconductive layer, and the step of forming the surface layer are continuously performed while maintaining a vacuum state by using a single CVD system.

11. The method of manufacturing an electrophotographic photoreceptor according to claim 1, wherein the step of roughening is performed by using a CVD method.

12. The method of manufacturing an electrophotographic photoreceptor according to claim 1, wherein the step of roughening, the step of forming the charge injection blocking layer, the step of forming the photoconductive layer, and the step of forming the surface layer are continuously performed while maintaining a vacuum state by using a single CVD system.

13. A method of manufacturing an image forming apparatus, comprising:
the method of manufacturing an electrophotographic photoreceptor according to claim 1; and
a step of installing a cleaning device in contact with a surface of the electrophotographic photoreceptor.

14. An electrophotographic photoreceptor manufacturing apparatus, comprising:
a surface roughening section which roughens an outer surface of an cylindrical base body so that a surface roughness of the outer surface of the cylindrical base body satisfies Str≥0.70, in which Str denotes texture aspect ratio;
a charge injection blocking layer forming section which forms a charge injection blocking layer on the outer surface of the cylindrical base body;
a photoconductive layer forming section which foul's a photoconductive layer on the charge injection blocking layer; and
a surface layer forming section which forms a surface layer on the photoconductive layer.

15. The method of manufacturing an electrophotographic photoreceptor according to claim 2, wherein the surface roughness of the outer surface of the cylindrical base body satisfies Sal≤8.4 μm in a state where the step of roughening has been performed, in which Sal denotes shortest autocorrelation length.

16. The method of manufacturing an electrophotographic photoreceptor according to claim 2, wherein the surface roughness of the outer surface of the cylindrical base body satisfies Sal≥0.3 μm in a state where the step of roughening has been performed, in which Sal denotes shortest autocorrelation length.

17. The method of manufacturing an electrophotographic photoreceptor according to claim 5, wherein the surface roughness of the outer surface of the cylindrical base body satisfies Sal≥0.3 μm in a state where the step of roughening has been performed, in which Sal denotes shortest autocorrelation length.

18. The method of manufacturing an electrophotographic photoreceptor according to claim 2, wherein the surface roughness of the outer surface of the cylindrical base body satisfies Sal≥0.6 μm in a state where the step of roughening has been performed, in which Sal denotes shortest autocorrelation length.

19. The method of manufacturing an electrophotographic photoreceptor according to claim 5, wherein the surface roughness of the outer surface of the cylindrical base body satisfies Sal≥0.6 μm in a state where the step of roughening has been performed, in which Sal denotes shortest autocorrelation length.
